(19) United States
(12) Patent Application Publication
(10) Pub. No.: US 2018/0118554 A1
(43) Pub. Date: May 3, 2018

(54) APPARATUS FOR DISPENSING VISCOUS LIQUIDS FROM A CONTAINER

(71) Applicant: SONE LLC, Milford, PA (US)

(72) Inventors: Jeffrey STARK, Westtown, NY (US); Mark SPRADING, Pond Eddy (NY); Richard A. DUBENSKY, Milford, PA (US)

(21) Appl. No.: 15/797,541

(22) Filed: Nov. 15, 2017

Related U.S. Application Data
(60) Provisional application No. 62/496,839, filed on Nov. 1, 2016.

(51) Int. Cl. B67D 7/02; B65D 35/28

(52) U.S. Cl. CPC B67D 7/0216; A47G 19/183; B65D 35/28

(57) ABSTRACT

A dispenser for dispensing a viscous liquid in a pliable container includes a housing having at least one sidewall and a bottom portion to define an interior enclosure for receiving the pliable container. The bottom portion has an opening configured to align with at least a portion of an opening of the pliable container. A compression assembly includes a compression member moveably positioned within the enclosure and a handle extending externally from the housing and coupled to the compression member to cause movement of the compression member about an axis, wherein manual movement of the handle moves the compression member about the axis and provides a lateral force on the pliable container such that the pliable container is compressed by the compression member and forces the viscous liquid to flow from the opening of the pliable container.

### CROSS-REFERENCE TO RELATED APPLICATION

This patent application claims priority to U.S. provisional Application No. 62/496,839, filed Nov. 1, 2016, the content of which is incorporated by reference herein in its entirety.

### FIELD OF INVENTION

The invention relates to liquid dispensers, and more specifically to manually operated viscous liquid dispensers.

### BACKGROUND OF INVENTION

In response to warnings from doctors and the health industry in general, there is a growing emphasis on farm fresh, preservative and chemical free, organic, non-GMO, natural ingredients in food. Many individuals are especially concerned about the risks and dangers of high fructose corn syrup, processed sugars, and artificial sweeteners. As a healthy substitute, they often prefer healthy alternatives like pure honey and maple syrup. However, consumption of these natural products is limited by consumers as compared to other sweeteners, since they can be viewed as being inconvenient to use for reasons often attributed to a sticky mess, waste, and risk of contamination.

For example, restaurants, caterers, hotels and other food service providers who serve prepared food for immediate consumption often avoid the use of non-single serve dispensers to dispense natural honey or syrups because of such waste, mess and contamination problems. Instead, the food service providers typically provide single-serve packages (e.g., plastic containers) of condiments, such as jams/jellies, honey and syrups. Although such prepackaged containers of honey, syrup and other viscous liquids can be somewhat convenient when traveling, they do not necessarily satisfy individuals who are seeking fresh ingredients or provide a more formal dining experience.

### SUMMARY OF THE INVENTION

The above disadvantages are avoided and/or solved by various embodiments of a viscous liquid dispensing apparatus as described below in further detail. The dispenser is configured to enable a user to manually dispense a viscous liquid such as, for example, honey or maple syrup in a safe, clean, and efficient manner without waste, mess, or risk of contamination.

In one embodiment, a dispenser for dispensing a viscous liquid in a pliable container comprises a housing having at least one sidewall and a bottom portion to define an interior enclosure for receiving the pliable container, where the bottom portion has an opening configured to align with at least a portion of an opening of the pliable container. A compression member is moveably positioned within the enclosure, and a handle extends externally from the housing and is coupled to the compression member to cause movement of the compression member about an axis, wherein manual movement of the handle moves the compression member about the axis and provides a lateral force on the pliable container such that the pliable container is compressed by the compression member and forces the viscous liquid to flow from the opening of the pliable container.

In one aspect, the dispenser further comprises a support coupled to the housing and configured to support and elevate the dispenser over a surface. In another aspect, the dispenser comprises a rotatable pin extending between opposing sides of the at least one sidewall, wherein the compression member and handle are fixedly attached to the rotatable pin and configured to rotate about a longitudinal axis of the pin. In yet another aspect, the housing is rectangular in shape. In still another aspect, the housing includes a top cover disposed over the at least one sidewall. In one aspect, the top cover includes a slot for receiving the handle. In another aspect, the compression member is a horizontally orientated rod.

In one aspect, the at least one sidewall is fabricated from metal. In yet another aspect, the at least one sidewall is fabricated from plastic. In still another aspect, the at least one sidewall is fabricated from ceramic. In yet another aspect, the at least one sidewall includes a slot for receiving the handle. In another aspect, the opening of the pliable container extends through the opening in the bottom of the housing.

In another embodiment, a dispenser for dispensing a viscous liquid in a pliable container comprises a housing having at least one sidewall and a bottom portion to define an interior enclosure for receiving the pliable container, wherein the bottom portion has an opening configured to align with at least a portion of an opening of the pliable container. A compression assembly includes a compression member that is moveably positioned within the enclosure and a handle extending externally from the housing and coupled to the compression member to cause movement of the compression member about an axis, wherein manual movement of the handle moves the compression member about the axis and provides a lateral force on the pliable container such that the pliable container is compressed by the compression member and forces the viscous liquid to flow from the opening of the pliable container.

In one aspect, the compression assembly is a curvilinear-shaped rod. In another aspect, the compression assembly includes a resilient member configured to interface with the housing and generally maintain the handle in an upright position. In yet another aspect, the resilient member is affixed to the compression member. In still another aspect, the at least one sidewall includes a plurality of paired orifices aligned vertically at varying heights and configured to receive the compression assembly and position the compression member at a predetermined height relative to the pliable container.

### BRIEF DESCRIPTION OF THE DRAWINGS

FIG. 1 is a top, right side perspective view of an illustrative embodiment of a viscous liquid dispenser of the present invention;

FIG. 2 is a schematic top, right side perspective view of the viscous liquid dispenser of FIG. 1 illustrating a movable compression assembly suitable for dispensing a viscous liquid from a pliable container;

FIG. 3 is a top, front perspective view of the dispenser of FIG. 1;

FIG. 4 is a top, rear perspective view of the dispenser FIG. 1;

FIG. 5 is a top plan view of the dispenser FIG. 1;

FIG. 6 is a top plan view of an interior enclosure of the dispenser FIG. 1;

FIG. 7 is a top plan view of an interior enclosure of the dispenser FIG. 1 with a pliable viscous liquid container inserted therein;

FIG. 8 is a top, right side perspective view of another illustrative embodiment of a viscous liquid dispenser of the present invention including a housing defining an enclosure, a container compression assembly, and a housing support member;

FIG. 9 is a right side elevated view of the dispenser of FIG. 8 illustrating the insertion and removal of a viscous liquid container;

FIG. 10 is an exploded, top, right side perspective view of the dispenser of FIG. 8 illustrating the housing, compression assembly and the housing support member;

FIG. 11 is a right side, top perspective view of the compression assembly suitable for use in the dispenser of FIG. 8;

FIG. 12 is a rear, right side perspective view of the compression assembly installed within the enclosure of the housing of FIG. 8;

FIG. 13 is a rear elevated view of the compression assembly installed within the enclosure of the housing of FIG. 8;

FIG. 14 is a top perspective view of the compression assembly installed within the enclosure of the housing of FIG. 8;

FIG. 15 is a right side, top perspective view of a compression assembly including a resilient member suitable for use in the dispenser of FIG. 8; and

FIG. 16 is a rear elevated view of the dispenser illustrating the compression assembly of FIG. 15 within the enclosure of the housing.

To further facilitate an understanding of the invention, the same reference numerals have been used, when appropriate, to designate the same or similar elements that are common to the figures. Further, unless otherwise indicated, the features shown in the figures are not drawn to scale, but are shown for illustrative purposes only.

### DETAILED DESCRIPTION OF THE EMBODIMENTS

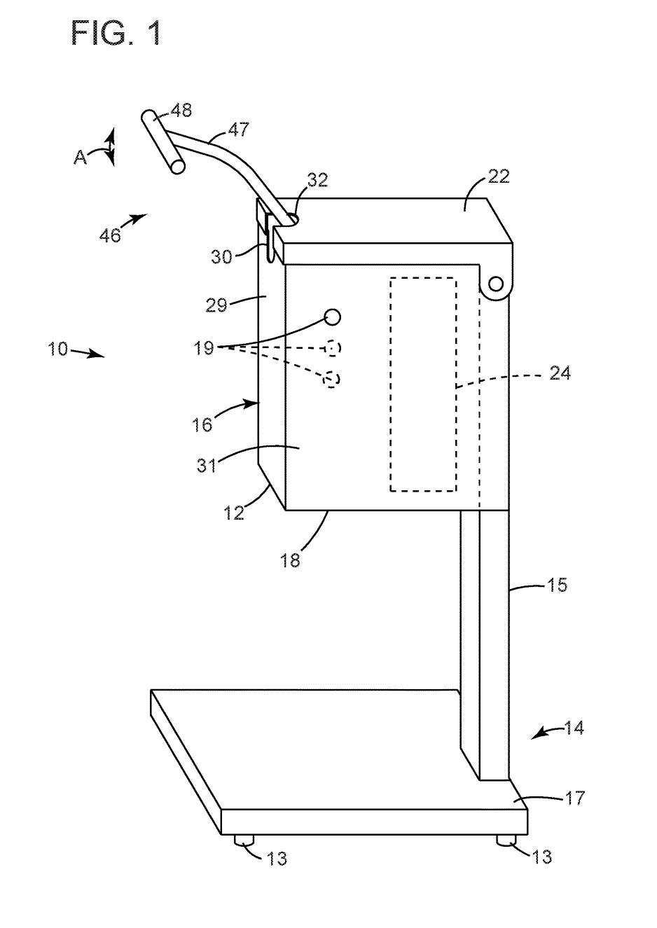

Referring to FIGS. 1-7 of the drawings, a manually operated device for dispensing viscous liquids is illustratively shown. The dispenser 10 can be used for selectively releasing viscous liquid products that are generally packaged in a pliable container (e.g., sixteen ounce container) that includes an opening (e.g., cap 52, nozzle and/or spout 53 and/or other self-closing orifice) which is provided to release the viscous liquid when the container 50 is squeezed. For example, the present dispenser 10 is suitable for use with plastic containers filled with honey, maple syrup or other viscous liquid products which are readily available to consumers in a supermarket, local marketplace, and the like. Although the dispenser 10 is discussed in terms of being used generally with food products, such as honey or syrup, such products are not considered limiting as the dispenser is suitable for use with other viscous liquids such as molasses, oils, glycerin, tar, among other viscous liquid products.

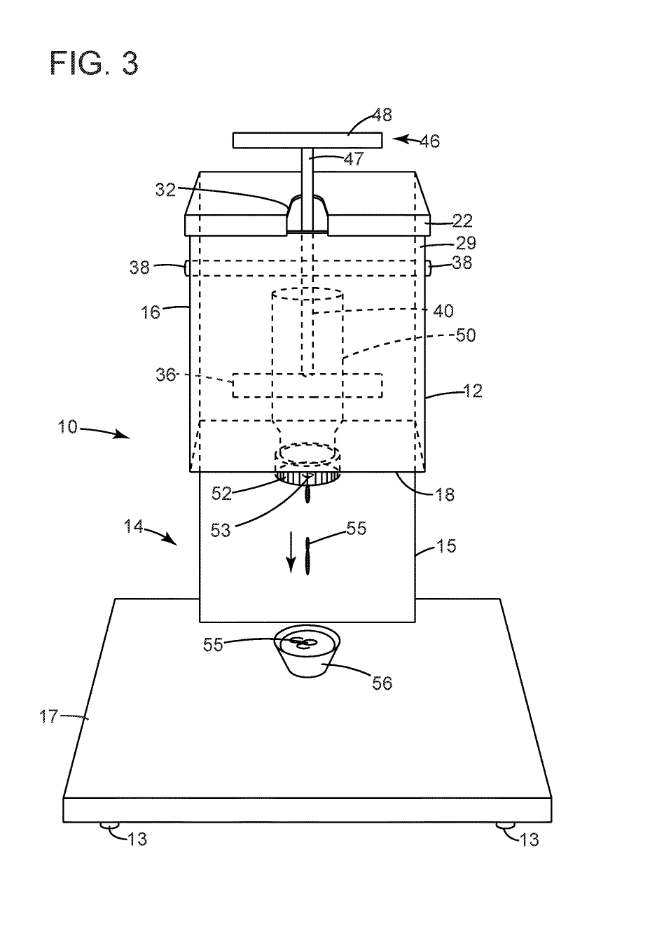

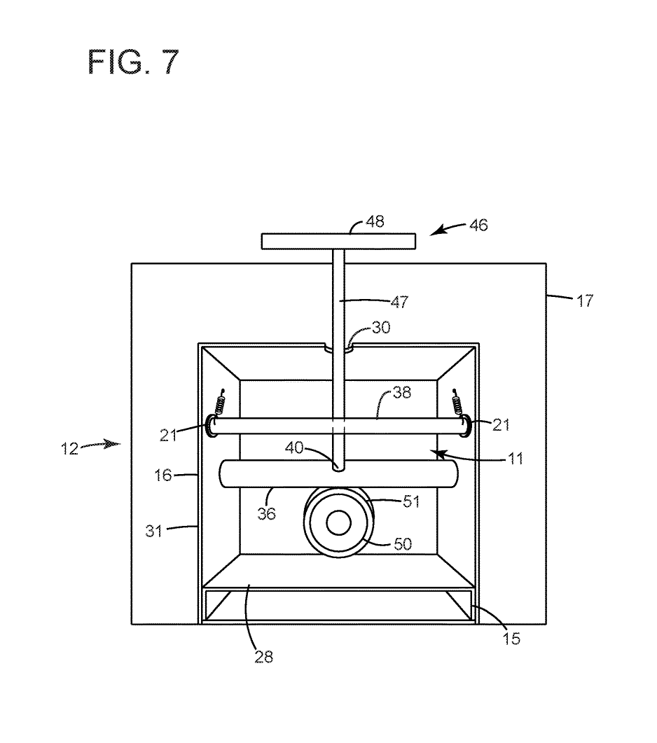

Referring to FIGS. 1-4, the dispenser 10 includes a housing 12 that is elevated via a support member 14 or stand. The housing 12 includes at least one sidewall 16 and a bottom portion 18, the interior surfaces of which collectively form an enclosure 20 for receiving a viscous liquid container 50 (see FIGS. 3 and 7), and a compression assembly 11 which is used for manually compressing the container 50 to force the viscous liquid to flow out of the container 50 in a downward direction as described m further detail below. Although the housing 12 and its enclosure 20 are illustratively shown as having a rectangular shape, such shape is not considered limiting. For example, the shape of the housing 12 can be oval, cylindrical, curvilinear or any other shape suitable to secure of the container 50 and dispense of the viscous liquid 55 therefrom.

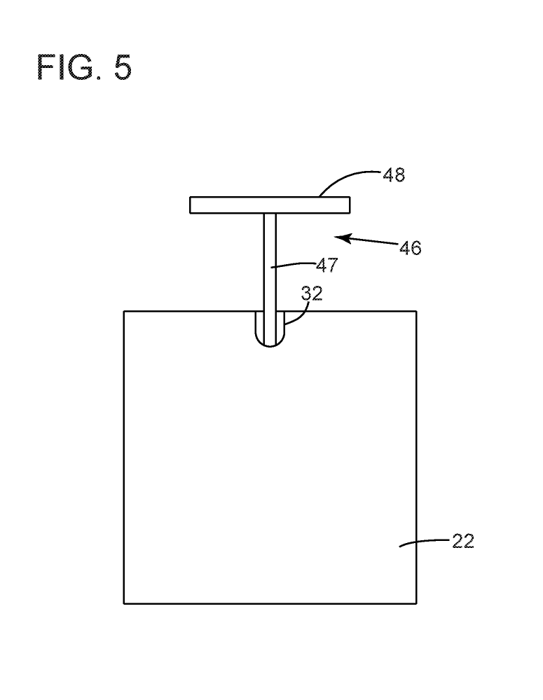

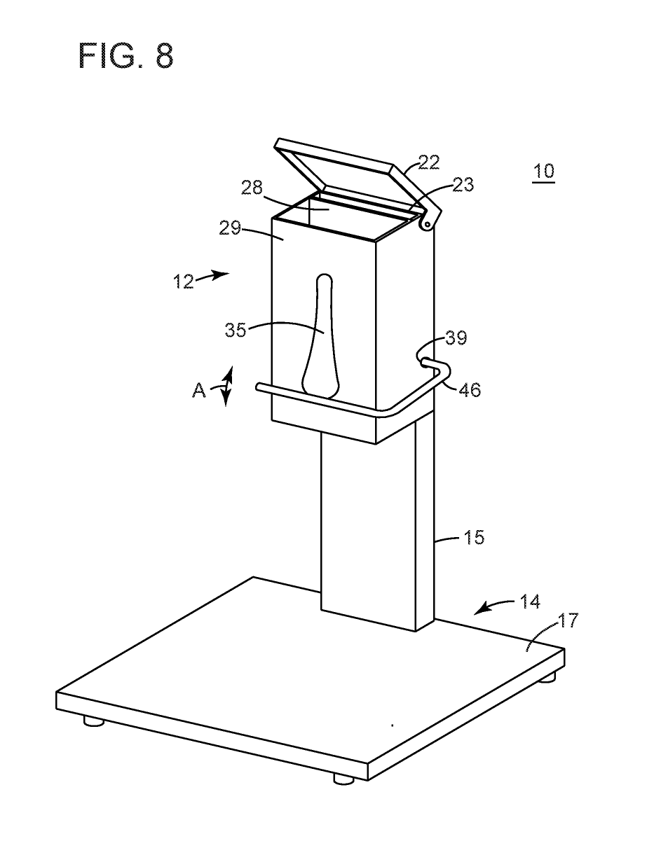

Referring to FIG. 5, the housing 12 includes a top cover 22 that can be removed or otherwise opened to provide access to the enclosure 20 for cleaning the interior, inserting a new container or removing an empty container 50, as required. The top cover 22 helps prevent foreign substances from contaminating the viscous liquid, and can be placed over and rest upon the housing sidewalls 16, or is preferably secured thereon by frictional forces therebetween, or by a snap-fit arrangement, or with the use of one or more fasteners (not shown). Alternatively, the top cover 22 can be hinged or otherwise rotatably attached (see, e.g., FIG. 8) to provide access to and closure of the interior portion (i.e., enclosure 20) of the housing 12. Although access to the enclosure 20 is shown as being provided at the top of the housing 12, such arrangement is not considered limiting. For example, a side panel or access door 24 (shown in phantom in FIG. 1) can be provided (e.g., hinged or slidably mounted) along a sidewall 16 of the housing 12 for accessing the enclosure 20.

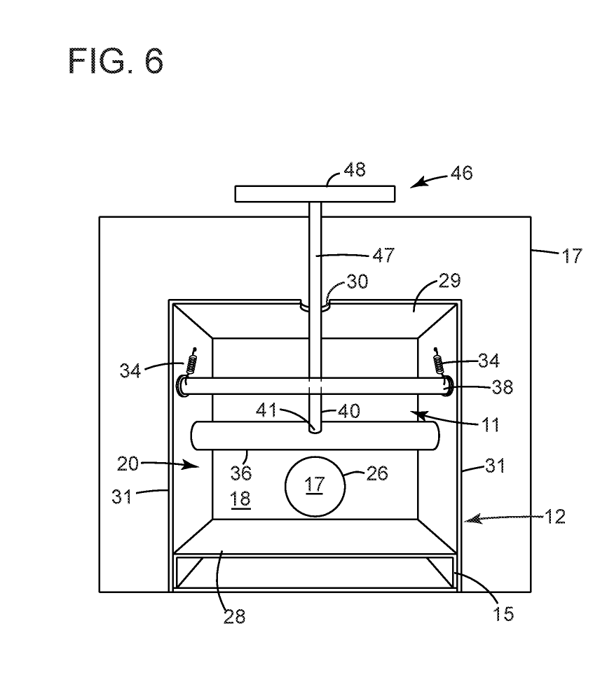

Referring to FIG. 6, the enclosure 20 is illustratively rectangular in shape formed by the interior surfaces of opposing rear and front sidewalls 28, 29 and adjacent lateral sidewalls 31 therebetween. The bottom portion 18 of the enclosure 20 is provided with an opening 26 extending therethrough which is configured to receive the cap 52 and nozzle/spout 53 (FIG. 3) or other opening in the viscous liquid container 50. The shape of the opening 26 is illustratively circular, but such shape is not considered limiting as other suitable shapes form the opening 26. Further, although the opening 26 is shown and discussed as being dimensioned to receive the cap 52, such configuration is not considered limiting as the opening 26 can be sized to receive only the nozzle/spout 53 of the container 50. The opening 26 formed through the bottom portion 18 is positioned between the rear interior sidewall 28 and a movable compression member 36 of the compression assembly 11, as described below in further detail.

Referring now to FIGS. 1, 3 and 4, the housing 12 is optionally elevated by a support member 14 or stand to enable the viscous liquid 55 to pour downward from its container 50 and conveniently flow, e.g., into a vessel, 56 (e.g., cup, bowl, dish and the like) provided by an end-user. The stand 14 is illustratively an L-shaped support having a vertical member or leg IS with a predetermined height that maintains the housing above a surface, such as a table or countertop, and a second horizontal leg or base member 17 which extends beneath the housing 12 and serves to support the dispenser 10 on the table or countertop. Although the drawings depict an L-shaped support with a base, such configuration is not considered limiting. For example, the dispenser 10 can be supported by a plurality of vertically directed support members, e.g., three or four support legs extending downward from the bottom portion 18. Although the stand 15 is illustratively shown integral to and at a fixed height, a person of ordinary skill in the art will appreciate that the support member 15 can be a separate component and/or can be adjustable (e.g., telescopic) to enable the end-user to adjust the height of the housing 12 over the table or countertop.

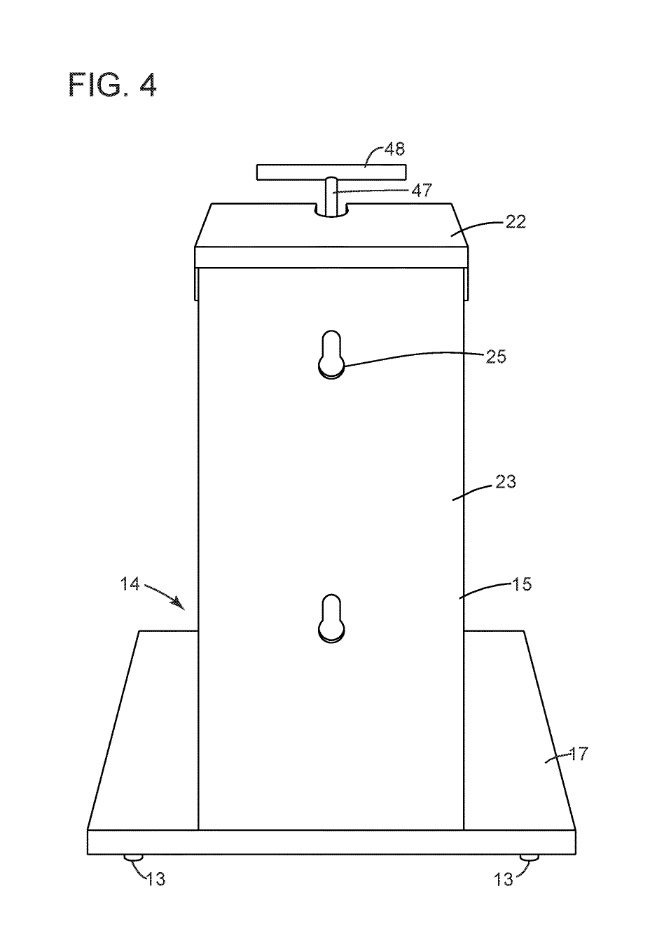

In another embodiment, the dispenser 10 can alternatively be hung from or mounted to a vertical wall (not shown) with the use of fasteners and/or brackets. Accordingly, the support member or stand 14 need not be integral with or included with the dispenser. Referring to FIG. 4, female receptacles 25 such as orifices, recesses and the like can be formed or provided in the rear panel 23 of the housing 12 to enable the housing 12 to be hung on a wall and supported by screws (not shown) or other fasteners in a well-known manner.

The dispenser 10 can be fabricated from a rigid or semi-rigid material such as a metal (e.g., aluminum, stainless steel, and the like), ceramic, plastic, glass and the like, or a combination of materials thereof. In one aspect, feet, pads or other base support members 13 (e.g., rubber, felt, among other materials) can be attached at the bottom of the stand 14 or base 17 to provide additional stability and greater frictional forces with the surface thereunder to prevent undesired movement (e.g., sliding) of the dispenser 10.

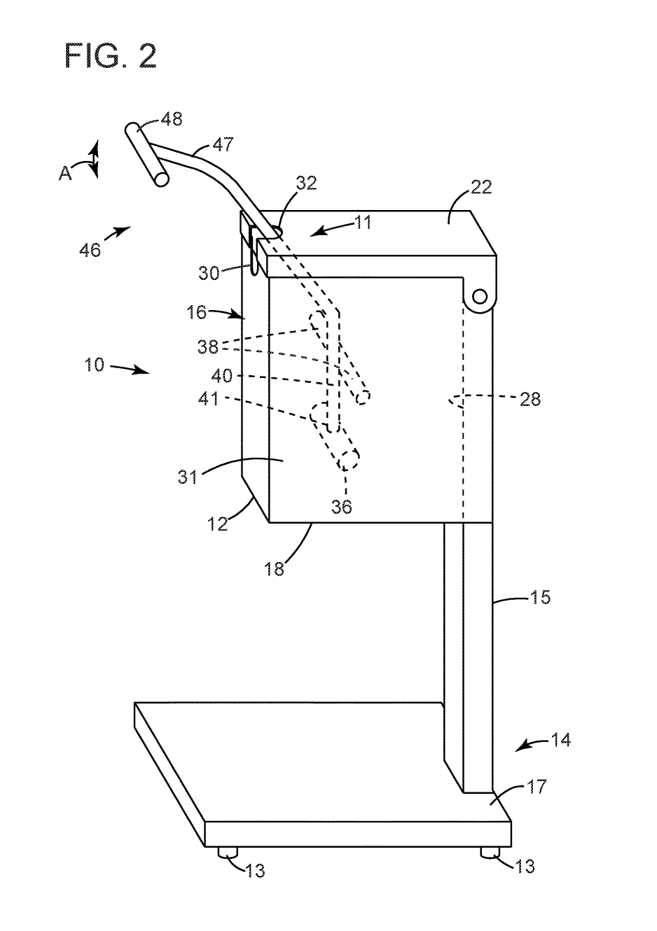

Referring now to FIGS. 2, 6 and 7, the moveable compression assembly 11 comprises a handle assembly 46, a compression member 36 and a pin 38, all of which are fixedly attached to an elongated rod 40 such that the handle assembly 46 is external to the housing 12 and the compression member 36 and pin 38 are positioned within the enclosure 20. The compression assembly 11 is pivotably connected to the housing 12 and functions as a lever. In one embodiment, the elongated rod 40 is curvilinear and includes one end 47 that forms a shaft 47 which is connected to a handle 48. The handle 48 is illustratively a second rod which is connected (e.g., welded or otherwise fastened) perpendicularly to the shaft 47, although the shape of the handle 48, the positioning relative to the shaft 47 and how it is fastened to the shaft 47 is not considered limiting. For example, the handle 48 can be a knob which is threaded onto or otherwise fastened to the end of the shaft 47, or a lever extending laterally outward from one side of the shaft, or an angled rod extending longitudinally from the shaft 47, and/or any other well-known or custom-shaped component extending from the shaft 47 which can be easily gripped and held by a hand of a user.

Referring to FIGS. 2 and 6, the compression member 36 is attached perpendicularly to the opposing end of the rod 40. The compression member 36 can be formed integrally with the rod 40 or can be attached by welding, an adhesive, fastener and/or the like. The compression member 40 is illustratively shown in the drawings as being cylindrical and extends substantially across the width of the enclosure 20 between the opposing lateral sidewalls 31. Those of ordinary skill in the art will appreciate that the shape of the compression member 36 is not considered limiting as other shapes are contemplated, e.g., a disk, spherical, oval, rectangular, curvilinear or other well-known or customized shapes, which are dimensioned to extend across a substantial portion of the sidewall 51 of the container 50 to thereby maximize compression forces when being applied to the container 50.

Movement of the compression member 36 is preferably facilitated by a pin attached to the rod 40 within the enclosure 20. The pin 38 extends a length between the opposing lateral sidewalls 31 of the housing 12 and is rotatable relative to the housing 12 by exerting an upward or downward force on the handle 48, as illustrated by arrow “A” in FIGS. 1 and 2. In one embodiment, each opposing end of the pin 40 extends through a corresponding bore or orifice 19 formed therethrough (FIG. 1) the adjacent lateral sidewalls 31 of the housing 12. Alternatively, opposing rings or collars 21 (FIG. 7) can be provided on each interior surface of the lateral sidewalls 31 to capture and retain the pin 38, while permitting rotation thereof. The pin 38 extends a length through the lateral sidewalls 31 (or collars 21) a distance sufficient to maintain the pin 38 in position with respect to the sidewalls 31 during use, but slippage can be provided to enable the end-user to slide the pin laterally so that the compression assembly 11 can be removed from the housing 12 for cleaning or storage of the dispenser 10.

The rotatable compression member 36 is preferably positioned within the housing 12 so that a mid-portion of the container sidewall 51 will be compressed by the compression member 36 during use. Compressing the mid-portion of the container 50 will allow for greater compression of the container, as opposed to compressing the bottom or top portions of the container 50. In one embodiment, a plurality of vertically aligned bores/orifices 19 (or collars 21) can be formed in the lateral sidewalls 31 of the housing 12 as illustratively shown in phantom in FIG. 1. In this manner, the user can position the compression assembly 11 so that the compression member 36 is more centrally located relative to different sized viscous liquid containers 50 so that an optimal compressive force can be applied to squeeze the liquid 55 from different sized containers 50.

The positioning of the compression member 36 relative to the pin 38 via the shaft 40 is based on the size (e.g., height) of the enclosure and diameter of the container 50. An optimal distance between the compression member 36 and pin 38 is such that the compression member 36 is spaced proximate to or against the container sidewall 51 while the handle assembly 46 is in a fully raised position. Accordingly, the end user need only push down slightly on the handle 48 to initiate the rotation of the compression member 36 against the container 50. In one embodiment, the compression member 36 can be weighted such that the handle assembly 46 normally remains in an upright position.

Referring to FIGS. 3 and 5, the front sidewall 29 includes a first slot or channel 30 formed at its upper end, and the top cover 22 includes a second slot or channel 32 which is aligned with the first slot 30 to enable the shaft 47 of the handle assembly 46 to extend and be rotated therethrough. The first and second slots 30, 32 are dimensioned to allow the shaft 47 to freely move without interference with the cover 22 or front sidewall 29. Although the compression assembly 11 and slots 30, 32 are illustratively shown centrally located with respect to the front sidewall 29 of the housing 12, such positioning is not considered limiting. For example, a person of ordinary skill in the art will appreciate that the attachment of the rod 40 and handle assembly 46 relative to the compression member 12 and pin 38, and enclosure 20 do not have to be centrally aligned. As such, the positioning of the shaft 47 relative to the front sidewall 29 and cover 22 determine the required location of the slots 30, 32. In yet another embodiment, the handle assembly 46 can extend directly from an end of the pin 38 which extend through a lateral sidewall 31 of the housing 12. In this latter embodiment, the slots 30, 32 would not be required.

Referring to FIGS. 1, 2 and 7, the compression assembly 11 is manually rotated by the end user to press against and thereby deform the pliable container 50 retaining the viscous liquid 55. The compression member 36 is illustratively shown positioned adjacent a sidewall 51 of the pliable container 50, but such positioning is not considered limiting. For example, depending on the configuration of the container, the compression member 36 could be positioned above the pliable container 50 to exert a downward force to maximize deformation of the container 50.

An end user can easily set up the dispenser 10 by lifting or removing the cover 22 (or side panel 24) to enable insertion of a pliable container 50 of the viscous liquid 55 (e.g., honey) into the enclosure 20 such that the container cap 52 and/or nozzle/spout 53 is aligned and/or extends through the opening 26 formed in the bottom portion 18 of the housing 12. The viscous liquid container 50 is positioned such that one sidewall 51 of the container 50 is adjacent an interior sidewall (e.g., rear sidewall 28) of the enclosure 20, and an opposing sidewall 51 of the container is adjacent to the compression member 36. The enclosure cover 22 (or side panel 24) is then closed to secure and protect the container 50 and viscous liquid 55 within the enclosure 20. A person of ordinary skill in the art will appreciate that the end user must ensure that the container nozzle or spout 53 is opened (if it is not a self-sealing opening) prior to or after insertion of the container 50 into the enclosure 20.

During operation, the end user grasps the handle 48 and rotates the handle assembly 46 in a downward direction towards the base 17 to rotate the compression member 36 about the central axis of the pin 38 and thereby push the compression member 36 against the adjacent sidewall 51 of the viscous liquid container 50. The downward force exerted by the user on the handle 48 causes the compression member 36 to apply a horizontally directed force that compresses the pliable container 50. In particular, the pliable container 50 is compressed between the compression member 36 and the adjacent opposing rear sidewall 28 of the enclosure to thereby force the viscous liquid 55 from the open nozzle/spout 53 of the pliable container 50.

Maintaining the downward force on the handle 48 causes a steady flow of the viscous liquid 55 from the container 50 to the vessel 56 or area directly below the dispenser housing 12. Releasing the handle 48 automatically causes the compression member 36 to move in a direction away from the sidewall 51 of the container 50, and thereby stops the flow of the viscous liquid 55 from the container 50. Specifically, the compression member 36 can be weighted so that its center of gravity causes the compression assembly 11 to rotate away from the sidewall 51 of the container 50. Alternatively, one or more springs 34 (FIG. 6) can be provided to rotate the pin 38 when the user releases the handle 48 so that the compression member 36 rotates in an opposite direction away from the container sidewall 51.

Referring now to FIGS. 8-16, a second embodiment of the dispenser 10 is illustratively shown. Referring to FIGS. 8-10, the second embodiment of the dispenser is the similar to the first embodiment described above with respect to the housing 12 forming an enclosure 20, a support member 14 for supporting the housing 12 over a surface (e.g., table or countertop), and a compression assembly 11 for manually compressing a container 50 filled with a viscous liquid 55. However, referring now to FIGS. 11 and 15, in the second embodiment of the dispenser 10, the compression assembly 11 is formed as a curvilinear member, which extends from a lateral sidewall 31 instead of the front 29 of the housing 12. Accordingly, the front sidewall slot 30 and cover slot 32 are not included.

Referring again to FIGS. 8-10, the dispenser 10 illustratively includes a rectangular shaped housing 12 forming an enclosure 20, although the shape of housing 12 is not considered limiting. A port or viewing window 35 can be formed in the front sidewall 29 to enable a user to view the amount of viscous liquid 55 remaining in the container 50 during use. The window 35 is illustratively tear-drop shaped, although such shape is not considered limiting as other shapes (e.g., oval, circular, rectangular, curvilinear and the like) are contemplated. The base 17 is illustratively curvilinear shaped with a linear edge along the rear and a curved edge extending along the sides and front portions of the housing 12, although such shape is not considered limiting.

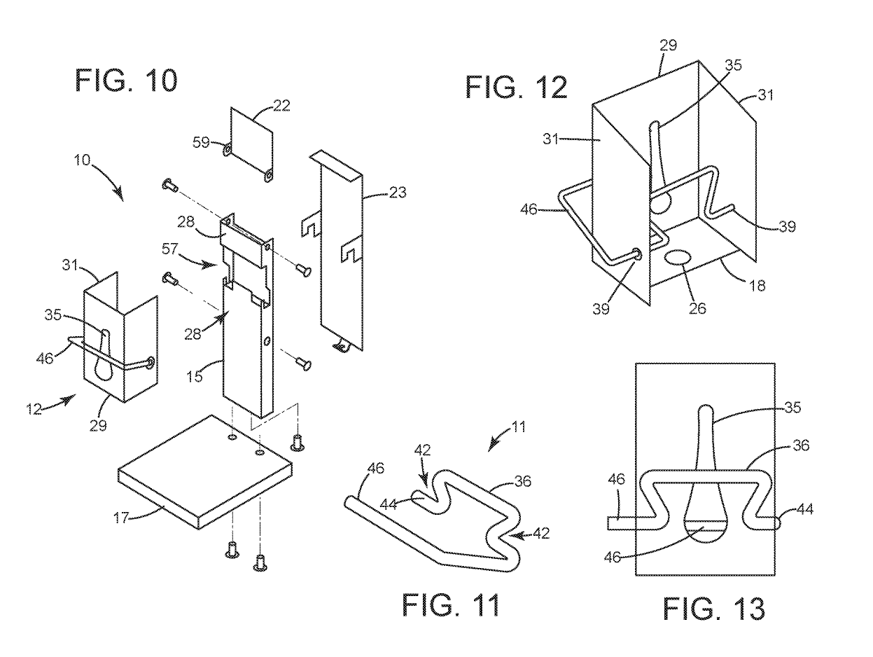

Referring now to the exploded view shown in FIG. 10, the vertical leg 15 of the support member 14 can extend from the base 17 vertically upward to the top rear portion of the housing 12 to thereby define at least a portion of the rear sidewall 28 of the enclosure 20. Optionally, a rear panel 23 can be fastened behind the support member 14 to further seal the enclosure 20 and provide additional support for the housing 12. A circular opening 26 dimensioned to receive the cap 52 and/or nozzle or spout 53 of the container 50 is formed through the bottom portion 18 of the housing 12, as illustratively shown in FIG. 12. As discussed above, the shape of the opening 26 is not considered limiting.

Referring to FIGS. 11-16, the compression assembly 11 is preferably formed from an elongated metal rod, such as stainless steel or aluminum, although such materials are not considered limiting. The compression assembly 11 is curvilinear in shape having a first portion that defines the compression member 36 and a second portion defining a handle assembly or lever 46. The housing 12 includes opposing orifices 39 formed through a lower portion of each lateral sidewall 31. The orifices 39 are sized to receive the compression assembly 11 and in one embodiment, enable at least a portion of the compression assembly 11 to be routed through the enclosure 20 such that the compression member 20 is positioned within the enclosure 20 and the handle 46 is external to the housing 12, as illustrated in the drawings.

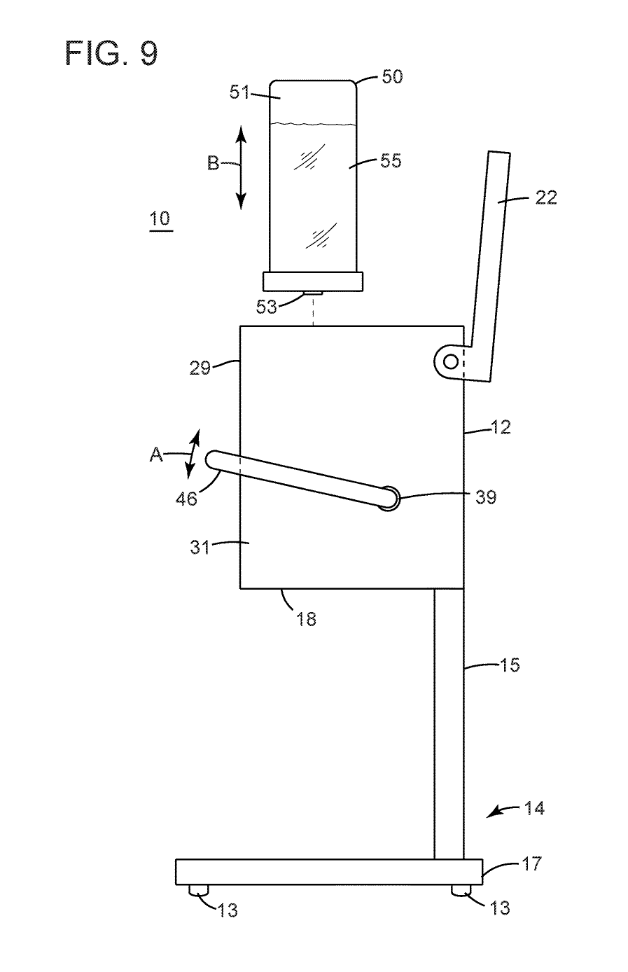

The compression member 36 and handle 46 are preferably integrally connected by a plurality of curvilinear portions or bends 42 which define a predetermined distance or spacing between the compression member 36 and the handle 46. The spacing therebetween enables a user to route the compression assembly 11 through and about the housing 12, as well as to push down on the handle 46, as shown by arrow “A” in FIGS. 8 and 9, to thereby rotate the entire compression assembly 11 when applying a compressive force against the viscous liquid container 50 inserted in the enclosure 20. Referring to FIG. 12, the compression assembly 11 is preferably routed into and out of the housing 12 by inserting a first end 44 located proximate the compression member 36 (i.e., the end opposite of the handle 46) through one of the lateral sidewalls 31 (e.g., the right lateral sidewall) and pulling/pushing the compression member 36 into the enclosure 20. The first end 44 is then aligned, inserted through and the second orifice 19 on the opposing lateral sidewall 31 to extend outwardly therefrom. The portions of the compression assembly extending through the pair of orifices 39 provide the focal points and axis for pivoting and rotating the compression assembly 11 within the enclosure 20. Although the compression assembly 11 is shown and described as being a single unitary component, a person of ordinary skill in the art will a appreciate that the compression assembly 11 can be fabricated from multiple rods which are threaded or otherwise fastened together. As well, the S-shaped bends 42 formed in the compression assembly can alternatively be provided by linear portions which are angled with respect to each other (e.g., at right angles) or other curvilinear shapes. Further, although the compression member 36 is shown as being linear, such shape is not considered limiting as other shapes (e.g., curvilinear shapes) can be utilized.

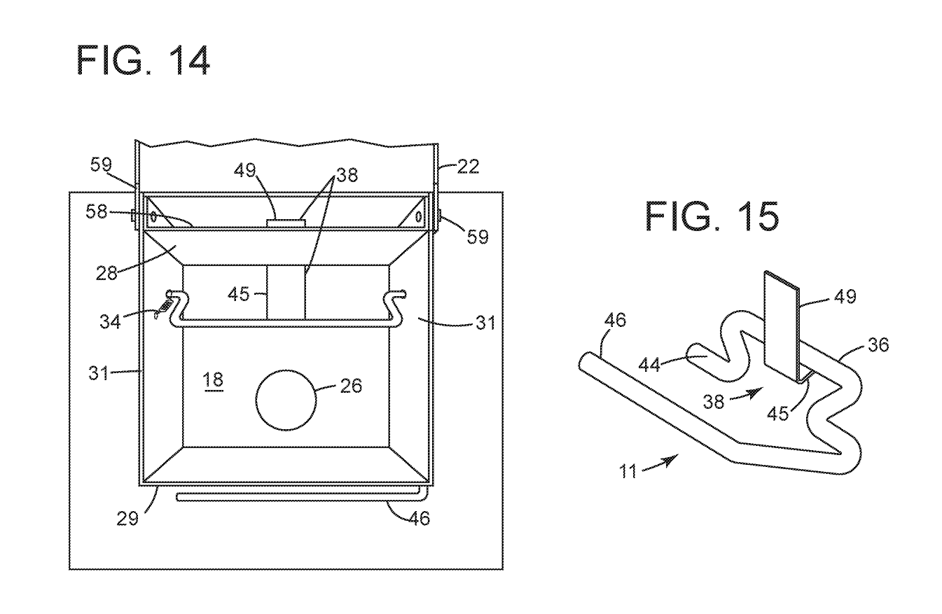

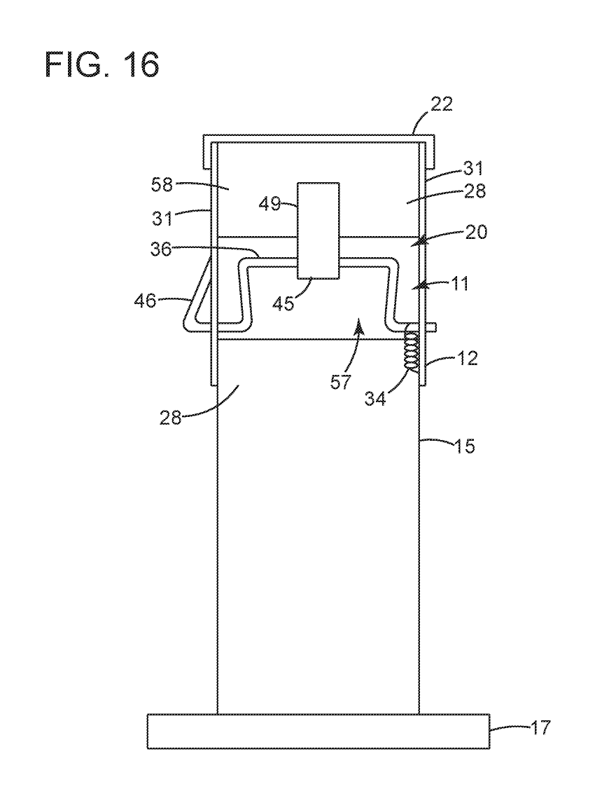

Referring now to FIGS. 14-16, the compression assembly 11 preferably includes a resilient member 38 attached to the compression member 36 to maintain the handle 46 in an upward/upright position and also return the handle back to the upright position after being pressed downward. In the illustrative embodiment shown in FIG. 15, the resilient member 38 is an L-shaped spring having a first leg 45 attached substantially horizontally to the compression member 36, illustratively by welding or a fastener, and a second leg 49 which extends substantially vertical and is positioned behind and against an outer surface 58 of the rear sidewall 28 as shown in FIGS. 14 and 15. More specifically, referring to FIGS. 10 and 16, the rear sidewall 28 includes a cutout or opening 57 which allows the second leg 49 of the resilient member 38 to be positioned against the outer surface 58 of the rear sidewall 28. As the compression assembly 11 is rotated, the second leg 49 can move freely up and down with respect to the outer surface 58. The height of the second leg 49 is sufficient to prevent the resilient member 38 from being displaced from the outer surface 58 during normal operation. The resilient member 38 has a spring constant suitable for enabling a user to easily push down on the handle 46 to compress the container 50 within the enclosure as described above with respect to FIGS. 1-7, and thereafter return the compression member 36 and handle 46 to its normal upright positioning. Although the resilient member 38 is illustratively shown and described as being attached to the compression member 36, a person of ordinary skill in the art will appreciate that one or more resilient members 38 can be attached to other portions of the compression assembly 11, e.g., proximate the first end 44 or other areas proximate the pivoting portion of the compression assembly and the lateral sidewalls 31 of the housing 12. Referring to FIGS. 14 and 16, one or more springs 34 are illustratively shown fastened at one of the pivoting areas of the compression assembly 11 and an adjacent lateral sidewall 31.

Preferably, the cover 22 is provided over the enclosure to protect the interior and contents from contaminants in the environment. Referring to FIGS. 9 and 10, the cover 22 can include downward projecting members 59 which are pivotally attached at the rear of the 12 housing by rivets or other fasteners extending through the projecting members 59 and lateral sidewall 31 of the housing 12. A person of ordinary skill in the art will appreciate that the cover 12 can be freely or rotatably attached to the housing 12 by other well-known techniques, such as by a spring-loaded hinge (not shown) or other fastener.

During operation, the user inserts and positions a container 50 of a viscous liquid, e.g., honey or syrup into the enclosure 20 (as illustrated by arrow “B” in FIG. 9) between the rear sidewall 28 and compression member 36 so that the cap 52 and/or nozzle/spout 53 extends through the opening 26 of the dispenser 10 (FIG. 12). A cup, dish or other vessel 56 can be positioned on the base 17 beneath the opening 26 and nozzle/spout 53 to receive the discharge of the viscous liquid. The user then pushes or pulls down on the handle 46 to rotate the compression member 20 in a direction towards the rear sidewall 28 of the enclosure 20 to compress or otherwise squeeze the container 50 and thereby dispense the viscous liquid 55 therefrom. The end user can control the amount of liquid being dispensed by the amount and duration of the force being applied to the handle 46. In this manner, a controlled pour or flow of the liquid 55 can be achieved without any mess or stickiness to the user's hands.

With respect to the various housing embodiments shown and discussed herein, a person of ordinary skill in the art will appreciate that the housing 12 can be configured to retain two or more viscous liquid containers 50, e.g., laterally adjacent to each other so that a single dispenser 10 can be used to dispense, for example, both honey and syrup from separate containers. For example, in both the first and second embodiments, the single housing can include an intermediate lateral sidewall which divides the enclosure 20 into two side-by-side sub-chambers, each of which having an opening 26 in the bottom sidewall 18 and a corresponding compression member assembly 11, as described above.

Advantageously, the various embodiments of the dispenser 10 offer food service organizations such as caterers, hotels, restaurants and the like with a superior device that can enhance the end-user's dining experience with minimal waste and mess. As well, using the dispenser 10 promotes an increase in consumption of pure honey and pure maple syrup, which benefits both the consumer and the farmers who produce these products.

While the foregoing is directed to embodiments of the present invention, other and further embodiments and advantages of the invention can be envisioned by those of ordinary skill in the art based on this description without departing from the basic scope of the invention, which is to be determined by the claims that follow.

What is claimed is:

1. A dispenser for dispensing a viscous liquid in a pliable container, comprising:
a housing having at least one sidewall and a bottom portion to define an interior enclosure for receiving the pliable container, the bottom portion having an opening configured to align with at least a portion of an opening of the pliable container;
a compression member moveably positioned within the enclosure;
a handle extending externally from the housing and coupled to the compression member to cause movement of the compression member about an axis, wherein manual movement of the handle moves the compression member about the axis and provides a lateral force on the pliable container such that the pliable container is compressed by the compression member and forces the viscous liquid to flow from the opening of the pliable container.

2. The dispenser of claim 1 further comprising a support coupled to the housing and configured to support and elevate the dispenser over a surface.

3. The dispenser of claim 1, wherein the interior enclosure is configured to receive and retain the pliable container adjacently between an interior sidewall and the compression member.

4. The dispenser of claim 1 further comprising a rotatable pin extending between opposing sides of the at least one sidewall, wherein the compression member and handle are fixedly attached to the rotatable pin and configured to rotate about a longitudinal axis of the pin.

5. The dispenser of claim 1, wherein the housing is rectangular in shape.

6. The dispenser of claim 1 further comprising a top cover disposed over the at least one sidewall.

7. The dispenser of claim 6, wherein the top cover includes a slot for receiving the handle.

8. The dispenser of claim 1, wherein the compression member is a horizontally orientated rod.

9. The dispenser of claim 1, wherein the at least one sidewall is fabricated from metal.

10. The dispenser of claim 1, wherein the at least one sidewall is fabricated from plastic.

11. The dispenser of claim 1, wherein the at least one sidewall is fabricated from ceramic.

12. The dispenser of claim 6, wherein the at least one sidewall includes a slot for receiving the handle.

13. The dispenser of claim 1, wherein the opening of the pliable container extends through the opening in the bottom of the housing.

14. The dispenser of claim 1, wherein the at least one sidewall includes a slot for receiving the handle.

15. A dispenser for dispensing a viscous liquid in a pliable container, comprising:
a housing having at least one sidewall and a bottom portion to define an interior enclosure for receiving the pliable container, the bottom portion having an opening configured to align with at least a portion of an opening of the pliable container;
a compression assembly including a compression member moveably positioned within the enclosure and a handle extending externally from the housing and coupled to the compression member to cause movement of the compression member about an axis, wherein manual movement of the handle moves the compression member about the axis and provides a lateral force on the pliable container such that the pliable container is compressed by the compression member and forces the viscous liquid to flow from the opening of the pliable container.

16. The dispenser of claim 15, wherein the compression assembly is a curvilinear-shaped rod.

17. The dispenser of claim 16, wherein the compression assembly includes a resilient member configured to interface with the housing and generally maintain the handle in an upright position.

18. The dispenser of claim 17, wherein the resilient member is affixed to the compression member.

19. The dispenser of claim 15, wherein the at least one sidewall includes a plurality of paired orifices aligned vertically at varying heights and configured to receive the compression assembly and position the compression member at a predetermined height relative to the pliable container.

20. The dispenser of claim 15, wherein the interior enclosure is configured to receive and retain the pliable container adjacently between an interior sidewall and the compression member.
